(19) United States
(12) Patent Application Publication
(10) Pub. No.: US 2025/0043611 A1
(43) Pub. Date: Feb. 6, 2025

(54) HINGE FOR DOORS

(71) Applicant: NUOVA STAR S.P.A., Zola Predosa (Bologna) (IT)

(72) Inventors: Marco VANINI, Zola Predosa (BO) (IT); Luca VANINI, Zola Predosa (BO) (IT)

(21) Appl. No.: 18/782,987

(22) Filed: Jul. 24, 2024

(30) Foreign Application Priority Data
Aug. 2, 2023 (IT) 102023000016419

(51) Int. Cl. E05F 1/12

(52) U.S. Cl. CPC E05F 1/1253; E05Y 2900/30

(57) ABSTRACT

Described is a hinge for doors of electrical household appliances, comprising a first element and a second element pivoted to each other and movable relative to each other in a tilting fashion, the first and second elements being fixable one to a frame and the other to a door of an electrical household appliance, for making the door movable with respect to the frame between a closed position and an open position, an arm for connection between the first and the second elements, a helical spring connected to the arm and designed to generate with its own deformation a force of elastic reaction designed to compensate at least partially the weight force of the door during the opening or closing of the door, means for adjusting the intensity of the elastic reaction force.

This application claims priority to Italian Patent Application 102023000016419 filed Aug. 2, 2023, the entirety of which is incorporated by reference herein.

This invention relates to a hinge for doors.

In particular, the invention relates to a hinge for doors of domestic appliances, such as, for example, dishwashers, etc., also designed to support further covering elements such as panels or the like.

The invention also relates to an electrical household appliance having a door and two respective hinges.

The refers purely by way of a non-limiting example to a front-opening household appliance such as a dishwasher.

The hinges used for the doors of domestic appliances normally consist of two elements kinematically connected to each other to move relative to each other in tilting fashion, with a first of these elements fixed to the door and a second of these elements fixed to the frame of the electrical household appliance.

An arm is normally interposed between the above-mentioned first and second elements on which elastic elements act which can dynamically influence the opening/closing of the door.

In short, the main function of the elastic elements acting on the arm is to oppose the weight force of the door and substantially balance it so as to keep it stably open at any angle of opening and, above all, to prevent its weight from causing its falling when opened.

The prior art hinges of the type described have the drawback of requiring, in order to adapt to the possible different dimensions and weights of the doors, the replacement of the elastic elements in such a way as to guarantee that an effective balance is achieved for each door.

This problem has without doubt been exacerbated over the years, with the success of electrical household appliances integrated into the furnishing of kitchens and the development of new covering materials, with the result of having doors with a wide range of weights and different from each other.

In fact, the same electrical household appliance can be combined, on the door, with different covering panels and these may be made of wood or its derivatives or of other materials, such as glass, resin, aluminium or composite materials.

In short, an electrical household appliance intended to mount a covering panel leaves the factory with hinges that will have to balance an unknown weight.

In order to overcome this problem, hinges have been developed wherein the elastic elements have complex means for adjusting the preloading, which operate by varying the axial extension of a spring, which is typically helical.

These solutions, even though functional, have not been found to be free from drawbacks, in particular with regard to their complexity which affects both the production costs and the assembly of the hinge.

The aim of the invention is to provide a hinge for doors which is able to overcome the drawbacks of the prior art and which is at the same time practical to use and simple and inexpensive to make.

A further aim of the invention is to provide a hinge for doors which is structurally simple and practical and effective to adjust.

According to the invention, these aims and others are achieved by a hinge for doors comprising the technical features described in the accompanying claims.

The technical features of the invention, according to the above-mentioned aims, are clearly described in the appended claims and its advantages are apparent from the detailed description which follows, with reference to the accompanying drawings which illustrate non-limiting example embodiments of it, and in which:

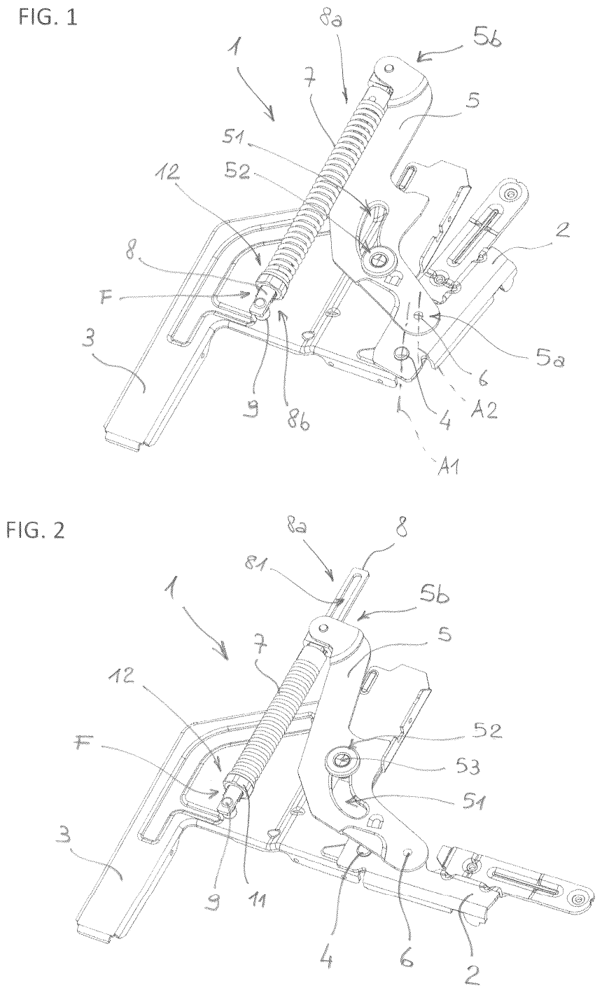

FIG. 1 is a schematic perspective view in a practically closed position of a hinge for doors according to the invention;

FIG. 2 is a schematic perspective view of the hinge of FIG. 1 in a relative open position;

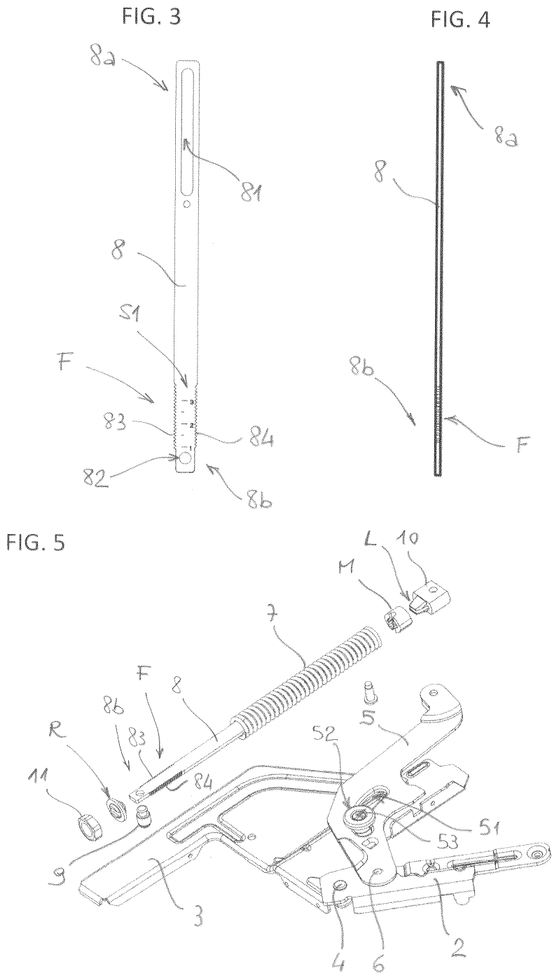

FIG. 3 is a schematic front elevation view of a detail of the hinge of the previous figures;

FIG. 4 is a schematic side elevation view of the detail of FIG. 3;

FIG. 5 is an exploded view of the hinge of FIG. 1;

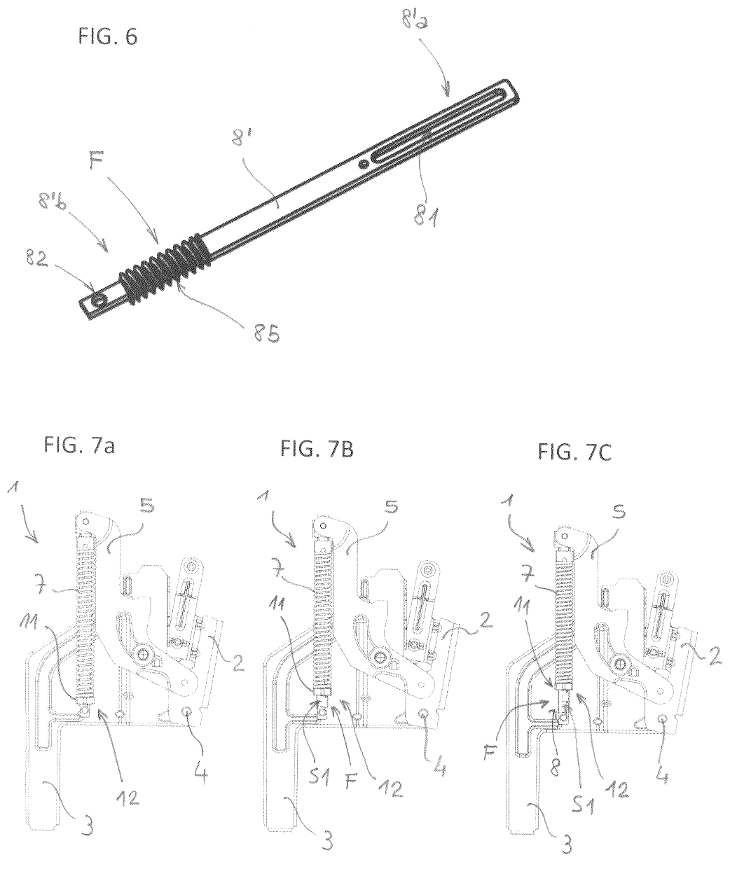

FIG. 6 is a schematic perspective view of another embodiment of the detail of FIGS. 3 and 4;

-FIGS. 7a, 7b and 7c show, in respective front elevation views, the hinge of FIGS. 1 and 2 in three relative different preloading configurations;

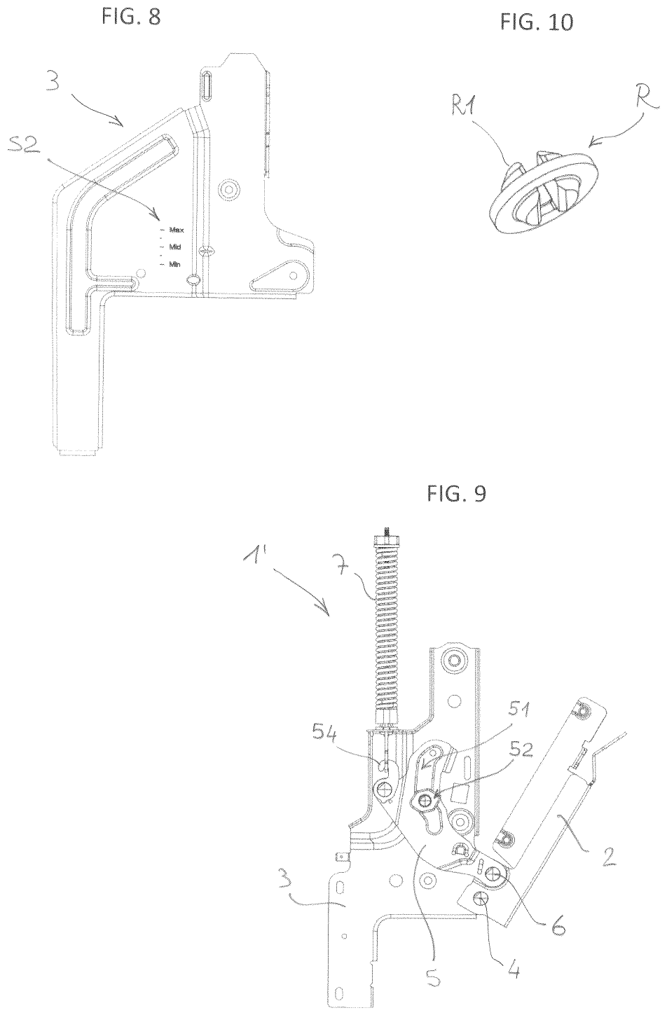

FIG. 8 is a front elevation view of a variant embodiment of an element of the hinge of the preceding drawings;

FIG. 9 is a scaled-up view of a detail of FIG. 5;

FIG. 10 is a front elevation view of a variant embodiment of the hinge according to the invention.

As illustrated in FIG. 1, the numeral 1 denotes in its entirety a first embodiment of the hinge for doors according to the invention.

The hinge 1, paired with another one, is designed to be mounted on an electrical household appliance, such as a dishwasher, to connect the frame to the relative door, both not illustrated, in such a way that the latter is movable in a tilting fashion and, in other words, to render the door movable with respect to the frame between a closed position and an open position and vice versa.

With reference to the accompanying drawings, the hinge 1 comprises a first element 2 designed for fixing to the above-mentioned, not illustrated door of the electrical household appliance, and a second element 3, of a box-shaped type, designed for fixing to the above-mentioned, not illustrated frame of the electrical household appliance.

The term box-shaped, referred to the element 3, means an element made of sheet metal, pressed and partly folded, designed to define support and housing for further components of the hinge.

The first element 2 is pivoted to the second element 3 by a pin 4 to allow reciprocal rotation of the first and second elements 2, 3 about a respective axis of rotation A1.

The axis of rotation A1 defines the axis of rotation of the above-mentioned, not illustrated, door relative to the above-mentioned frame, also not illustrated.

The above-mentioned first and second elements 2 and 3 are kinematically connected to each other by a connecting arm 5.

At a relative first end 5a, the connecting arm 5 is pivoted to the first element 2 by a pin 6, in such a way as to rotate at least partly with respect to the first element 2 about a respective axis A2.

A slot 51 is made on the connecting arm 5.

The slot 51 slidably engages with its peripheral edge with a guide pin 52, integral with the second element 3 by means of a rivet 53.

The hinge 1 also comprises a helical spring 7 and a flat control rod 8 of the spring 7, both supported by the second, box-shaped element 3.

The helical spring 7 defines, for the hinge 1, an elastic element connected to the above-mentioned arm 5 and designed to generate, with a relative deformation, an elastic reaction force designed to compensate at least partly for the weight force of the above-mentioned and not illustrated door during its opening or closing.

The flat control rod 8 is made from sheet metal and defines means for operational connection between the above-mentioned arm 5 and the helical spring 7.

As illustrated in FIG. 3, in a relative upper zone 8a the flat control rod 8 has a slot 81 with a longitudinal extension.

At its lower zone 8b, the flat control rod 8 is connected to the second element 3 by a relative pin 9 engaging inside a respective hole 82, made in the flat control rod 8.

Advantageously, the flat control rod 8 is made by cutting from sheet metal, since this method makes it possible to achieve quickly and economically the forming of the flat rod 8, its slot 81 and the hole 82.

At a relative second end 5b, the connecting arm 5 supports a slider 10 which is slidably engaged in the slot 81 made in the flat connecting rod 8.

Following the movement of the connecting arm 5 resulting from the movement of the first element 2, the slider 10 compresses the helical spring 7.

In other words, as illustrated in FIG. 2, the slider 10 is designed to engage with an upper end coil of the spring 7 in such a way as to compress the spring 7.

As illustrated in FIG. 3, again at its lower zone 8b, the flat control rod 8 has a threaded portion F.

The slider 10 has two tabs L projecting downwards designed to engage with the two opposite flat faces of the flat control rod 8.

The hinge 1 also comprises a hollow cylindrical sleeve M, shown in FIG. 5, shaped to match the tabs L of the slider 10 to engage them slidably in contact with the flat control rod 8 and to promote a damping action of the overall movement of the hinge 1.

In other words, when the slider 10 compresses the helical spring 7, its tabs L are pushed against the above-mentioned sleeve M which has a converging shape inside it such as to cause a compressive action of the tabs L on the flat control rod 8 interposed between them, thereby increasing the friction in the mutual sliding between rod 8 and tabs L and thereby generating the above-mentioned damping action.

According to the embodiment illustrated in FIGS. 1 to 5, the flat control rod 8 has two toothed zones 83, 84 made on two opposite lateral edges of it, the two toothed zones 83, 84 being designed to form the above-mentioned threaded portion F.

The two toothed zones 83, 84 are made by cutting the above-mentioned metal sheet from which the flat control rod 8 is formed.

In other words, as mentioned above, since the flat control rod 8 is made by cutting from sheet metal, during the same cutting step which gives shape to the flat rod 8, to its slot 81 and to its hole 82, the above-mentioned two toothed zones 83, 84 are also advantageously formed.

With reference to FIGS. 1, 2 and 5, the hinge 1 comprises a nut 11 designed to engage by screwing on the above-mentioned threaded portion F.

As illustrated in FIGS. 1 and 2 and as explained in more detail below, with the helical spring 7 fitted on the flat control rod 8 and the nut 11 engaged by screwing on the threaded portion F, a variation in the screwing of the nut 11 on the threaded portion F determines a simultaneous variation of the compression of the helical spring 7 and, consequently, a variation of its preloading force, that is to say, a variation of the method with which the hinge 1 actuates the balancing of the door of the electrical household appliance during its opening/closing steps.

Advantageously, as illustrated in FIG. 3, at the above-mentioned threaded portion F, on the flat control rod 8 there is a graduated scale S1 configured to indicate the position of the nut 11 and the corresponding preloaded condition of the helical spring 7.

FIGS. 7a to 7c show the different position of the nut 11 and the corresponding indication on the graduated scale S1.

In FIG. 6 the reference numeral 8′ denotes an alternative embodiment of the flat control rod 8 described above and illustrated in FIGS. 3 and 4.

The rod 8′ differs from the rod 8 described above by the different shape of the threaded portion F.

The remaining parts of the rod 8′ coincide with those described above with reference to the rod 8.

More in detail, as illustrated in FIG. 6, the flat control rod 8′ has a threaded portion F made of plastic material by co-moulding on the flat metal part of the rod 8.

In other words, the threaded portion F is defined by a helical thread 85 made of plastic material having a cylindrical shape.

The expression “cylindrical shape” is used to mean that the helical thread extends continuously, not being limited only to the lateral edges of the flat totally metallic rod 8 described above.

Similarly to what is described above with reference to the flat, entirely metal control rod 8, the helical thread 85 made of plastic material is also designed to engage by screwing a respective nut 11 by means of the screwing of which it is possible to vary the compression of the helical spring 7 and, consequently, the extent of the preloading force of the spring 7.

FIG. 8 illustrates a variant embodiment of the box-shaped element 3 having a graduated scale S2 configured to indicate the position of the nut 11 on the flat control rod 8, 8′ and the corresponding preloaded condition of the helical spring 7. The position of the graduated scale S2 on the box-shaped element 3 is advantageous, for example, in the case of adopting a flat rod 8′ such as that illustrated in FIG. 6 wherein, that is to say, it is not possible to return the scale to the flat body of the rod due to the presence of the helical thread 85 made of plastic material.

The above-mentioned threaded portion F and nut 11 define together, for the hinge 1 according to the invention, respective means 12 for adjusting the intensity of the elastic reaction force.

Advantageously, the means 12 for adjusting the intensity of the elastic reaction force comprise a washer R, shown in FIG. 5, interposed between the nut 11 and an end coil of the helical spring 7.

As illustrated in FIG. 9, the washer R has a rectangular central opening designed to allow the flat control rod 8 to pass through it and, advantageously, a truncated cone shaped portion R1 configured to penetrate into the lower end coil of the helical spring 7 and thus favour the centring of the helical spring 7 relative to the flat control rod 8.

The washer R is advantageously made of plastic material which is capable of applying, by friction, an effective anti-unscrewing action on the nut 11, so as to guarantee the stable maintaining of the position of the nut 11 on the flat control rod 8 and the simultaneous preloaded condition of the helical spring 7, also following continuous use of the electrical household appliance on which the hinge 1 is mounted.

The hinges 1 illustrated and described herein are, in use, applied in pairs to an electrical household appliance, such as a dishwasher, having a door movable in a tilting fashion, located at lateral ends of the door.

FIG. 9 shows a variant embodiment, denoted by the reference numeral 1′, of the hinge according to the invention.

The hinge 1′, differs from the hinge 1 of FIGS. 1, 2 and 5 in that it has a different architecture, wherein, basically, the helical spring 7 is compressed by the movement of the connecting arm 5 which is hooked to a lower end of the flat control rod 8.

The flat control rod 8 is therefore mounted on the hinge 1′ which is substantially inverted relative to the hinge 1, that is to say, with the slot 81 at the bottom to engage the hook 54 of the arm 5 and with the threaded portion F at the top, thereby engaging the respective nut 11.

With reference to FIGS. 7a to 7c, the hinge 1 is shown n use in a substantially closed configuration corresponding to a substantially closed position of the door, not illustrated, of the dishwasher.

In FIG. 7a the nut 11 is very close to the pin 9 for connecting the rod 8 to the element 3, being engaged to the minimum by screwing on the threaded portion F.

This condition of the nut 11 determines the condition of minimum preloading of the helical spring 7.

In FIG. 7b, the nut 11 appears spaced from the pin 9 since the nut 11 has obviously been screwed more, thereby increasing the compression of the helical spring 7 and, consequently, increasing its preloading.

In FIG. 7c, the nut 11 is even more spaced from the pin 9, thereby further increasing the compression of the helical spring 7 and, consequently, increasing its preloading up to a maximum value coinciding with the upper end of the threaded portion F.

In short, under equal conditions of position of the control rod 8, since the nut 11 is positioned in series with the helical spring 7, its movement relative to the rod 8 (by screwing on its threaded portion F) ends up varying the deformation of the spring 7 and therefore, in other words, its preloading.

In fact, as known, in a spring, the intensity of the elastic reaction force of the spring is a function both of the relative elastic constant of the spring and of the deformation to which the spring is subjected. In the example illustrated in the accompanying drawings, the helical spring 7 extends longitudinally along the direction of extension of the rod 8 and the deformation to which the spring 7 is subjected is a compression along that direction.

For this reason, starting from the configuration adopted by the hinge 1 in FIG. 7a, using a normal hexagonal wrench engaged with the nut 11, it is possible, by overcoming the elastic reaction force of the spring 7, with a screwing action, to compress the helical spring 7 to make it adopt the configurations of FIGS. 7b and 7c or also multiple intermediate configurations not illustrated.

As described above, the compression of the helical spring 7 causes an increase in the elastic reaction force generated by the spring 7.

This increase in the elastic reaction force of the helical spring 7 allows the hinge 1 in the configuration of FIG. 7c to balance the doors which are heavier compared with those which would have balanced in the relative configuration of FIG. 7b or 7a, that is to say, with a lower preloading.

The hinge 1 according to the invention is therefore able to perform different balancing actions, gradually increasing according to the degree of screwing (away from the pin 9) of the nut 11 on the threaded portion F.

The hinge 1 for doors according to the invention achieves the preset aims and brings important advantages.

A first advantage is due to the fact that by means of the hinge 1 according to the invention, it is advantageously possible to modify in a fast and effective manner the intensity of the elastic reaction force of the helical spring and, consequently, the intensity of the balancing action applied on the door, by means of a simple adjustment operation actuated by screwing or unscrewing the nut 11.

A further advantage is due to the fact that the making of the control rod on which the helical spring is fitted is particularly simple and inexpensive, not requiring, for the preparation of its threaded portion, any precision mechanical processing.

The use of alternative types of springs different from the helical ones is to be considered, for the purposes of the invention, to be considered as simply a technical equivalent if the springs are in any case capable of deforming by compression and increasing its elastic reaction force if compressed.

An example of equivalent alternative springs consists of cup-shaped springs.

1. A hinge for doors of electrical household appliances, comprising:
a first element and a second element pivoted to each other and movable relative to each other in tilting fashion, said first and second elements being fixable one to a frame and the other to a door of an appliance, to make the door movable with respect to the frame between a closed position and an open position,
a connecting arm between said first and second elements,
an elastic element connected to said connecting arm and designed to generate, by means of its own deformation, an elastic reaction force to compensate at least partially the weight force of the door during its opening or closing,
a flat control rod for said elastic element, said flat control rod being made from sheet metal and defining an operative connecting means between said arm and said elastic element,
means for adjusting the intensity of said elastic reaction force, characterised in that said adjusting means comprise a threaded portion formed in said control rod and a nut engaging by screwing on said threaded portion to continuously adopt different positions at which said elastic element adopts as many different deformed configurations.

2. The hinge according to claim 1, wherein said flat control rod has two toothed zones formed on two opposite lateral edges, said toothed zones being designed to form said threaded portion and screwably engage with said nut.

3. The hinge according to claim 2, wherein said toothed zones of said flat control rod are made by cutting said metal sheet.

4. The hinge according to claim 1, wherein said threaded portion is made of plastic material by co-pressing on said flat control rod made of metal.

5. The hinge according to claim 4, wherein said threaded portion made of plastic material has a cylindrical shape.

6. The hinge according to claim 1, wherein said means for adjusting the intensity of said elastic reaction force comprise a washer interposed between an end of said elastic element and said nut.

7. The hinge according to claim 6, wherein said washer has at least one truncated cone portion designed for centring said elastic element with respect to said flat control rod.

8. The hinge according to claim 1, wherein said flat control rod has a slot with a longitudinal extension.

9. The hinge according to claim 8, wherein it comprises a slider slidably engaged in said slot with a longitudinal extension and configured for actuating the compression of said helical spring.

10. The hinge according to claim 1, wherein it has, formed on one of either said flat control rod or said second element, a graduated scale configured to indicate the position of said nut along said flat control rod and the corresponding preloaded condition of the elastic element.
